(19) United States
(12) Patent Application Publication
(10) Pub. No.: US 2002/0062267 A1
(43) Pub. Date: May 23, 2002

(54) Customer information management system and customer information management method for call sales

(75) Inventors: Kenji Tsumura, Saga-ken (JP); Kiyonori Mochizuki, Saga-ken (JP)

Correspondence Address: JORDAN AND HAMBURG LLP, 122 EAST 42ND STREET, SUITE 4000, NEW YORK, NY, 10168, US

(73) Assignee: Kentop Corporation, Saga-shi (JP)

(21) Appl. No.: 09/915,742

(22) Filed: Jul. 26, 2001

(30) Foreign Application Priority Data
Nov. 17, 2000 (JP) 2000-351786

(51) Int. Cl. G06F 17/60

(52) U.S. Cl. 705/27

(57) ABSTRACT

There is provided a customer information management system for use in call sales that enables a salesperson to complete the registration of contents of a contract at a customer's place and enables a call sales company office to ascertain immediately the contents of the contract. Contents of part of categories of the product detail information or customer information to be input using the HT 6 are registered in the DB 2a as a temporary information master register 10 in advance. The temporary information master register 10 is acquired by the communication means 16 of the HT 6 via the PC 3 by a connection to the SC 2, and the customer information and product detail information are input into the HT 6 by the input means 13 using the acquired temporary information master 10. The input customer information and the product detail information are transferred by the communication means 16 of the HT 6 via the PC 3 by a connection to the SC 2, and in the SC 2 the transferred customer information and product detail information are recorded by the recording means 18 in the customer master register 11 and the product detail file 12 respectively in the DB 2a. The customer master register 11 and the product detail file 12 are then acquired from the DB 2a by the output means 19 and output.

### BACKGROUND OF THE INVENTION

1. Field of the Invention

The present invention relates to a customer information management system and a customer information management method for registering and managing information about newly developed customers in the field of call sales of medical supplies and various other products.

2. Description of the Related Art

In the field of call sales of medical supplies and the like, conventionally, a system has been used in which a medicine chest containing several types of medicines having various effects is delivered and consigned to a customer. After an appropriate time has passed, a call sales operator (referred to below as a “salesperson”) visits the customer and receives payment from the customer for those medicines that the customer has used from the medicine chest and also replenishes the supplies of the used medicines.

Conventionally, in the field of call sales, when developing new customers to whom call sales may be made, the salesperson calls on each potential customer with both a contract and products and records on the spot information such as the address, name, telephone number, and details of the products to be consigned of a new customer on a duplicate contract that doubles as a statement of consignment. The salesperson takes the duplicate copy of the contract/statement of consignment back to the office, and inputs the contents of the contract/statement of consignment using a registration terminal in the office thereby registering the customer in the customer master register or the like.

According to the above-described method, at the time the contract is entered into, the salesperson records the details of either all or almost all of the categories on the contract/statement of consignment by hand at the customer's home. In order to increase the number of contracts, the salesperson needs to call on more and more customers; however, because the recording of the details on each contract/statement of consignment takes time, the visiting efficiency is reduced and the number of contracts is not as many as should be possible. Moreover, the contract agreement tends to be completed before the call sales products are sufficiently explained to the customer. This has often resulted in the reduction of the quantity of call sales products to be used until the next visit by the salesperson.

Furthermore, because the contents of the contract/statement of consignment are input into the registration terminal again by hand based on the contract/statement of consignment which the salesperson has brought back to the office, even more time is required for this input. In addition, when carrying out the input by hand, there is the concern that mistakes in the input may occur as a result of the information being recorded in a scrawly manner on the contract/statement of consignment.

Moreover, because the office is not informed of the contents contracted with the customer until the salesperson returns to the office, the office is unable to respond to complaints from the customer that arise immediately after the contract has been entered into. Accordingly, the office needs to wait until the salesperson returns to the office before responding to a claim. However, because complaints from customers often arise immediately after the contract has been entered into, the fact that the complaints cannot be dealt with immediately causes problems from a business standpoint.

### SUMMARY OF THE INVENTION

Therefore, in the present invention there are provided a customer information management system and a customer information management method for use in call sales that enable a salesperson to complete the registration of the contents of a contract at the customer's place and that enable the office to immediately ascertain the contents of the contract.

The customer information management system for use in call sales of the present invention comprises: a portable terminal used for inputting customer information relating to a newly developed customer and product detail information relating to details of a product delivered and consigned to a customer; and a server computer for managing a database used for storing a temporary information master register in which contents of a part of the categories of the customer information or product detail information to be input using the portable terminal are registered in advance, a customer master register in which the customer information relating to each of the customers are registered, and a product detail file in which the product detail information relating to each of the customers is recorded, wherein the portable terminal comprises means for making a connection to the server computer and acquiring the temporary information master register, means for inputting the customer information and product detail information using the acquired temporary information master register, and means for making a connection to the server computer and transferring the input customer information and product detail information; and the server computer comprises means for recording the transferred customer information and product detail information respectively in the customer master register and the product detail file and means for acquiring the customer master register and the product detail file from the database and outputting the customer master register and the product detail file.

In the customer information management method for use in call sales of the present invention, customer information relating to a newly developed customer and product detail information relating to details of a product delivered and consigned to a customer are input using a portable terminal, the input customer information and product detail information are transferred to a server computer for managing a database for storing a customer master register in which customer information relating to each of the customers is registered and a product detail file in which product detail information relating to each of the customers is recorded, wherein contents of part of the categories of the customer information or product detail information to be input using the portable terminal are registered in advance in the database as a temporary information master register, the temporary information master register is acquired by being connected to the server computer using the portable terminal, the customer information and product detail information are input into the portable terminal using the acquired temporary information master register, the input customer information and product detail information are transferred to the server computer by being connected to the server computer using the portable terminal, the transferred customer information and product detail information are recorded respectively in a customer master register and a product detail file in the server computer, and the customer master register and product detail file are acquired from the database in the server computer and output.

As a result of these inventions, for a customer newly developed by a visit by a salesperson, it is possible to more easily input into the portable terminal the customer information and product detail information that relates to the details of a product consigned to the customer based on a temporary information master register. Moreover, the salesperson transfers the input information to a server computer to register the information in the customer master register and the product detail file each time he or she inputs the information into the portable terminal, it is possible for the office to immediately ascertain the contract contents by acquiring the customer master register and the product detail file from the database using the server computer and then outputting these.

Here, it is preferable that the portable terminal further comprises: means for outputting the input product detail information, and means for inputting authentication information showing that customer authentication has been obtained for the output product detail information. In addition, after the customer information and product detail information have been input into the portable terminal, the input product detail information is output using the portable terminal; authentication information showing that customer authentication of the output product detail information has been obtained is input; and the input authentication information is transferred to the server computer.

By the above structure, at the customer's place, the salesperson outputs and confirms to the customer the product detail information for the consigned products which has been input into the portable terminal and, after confirmation by the customer, inputs the fact that customer authentication has been obtained into the portable terminal to transfer this to the server computer. Thus, it is possible to prevent input errors or the like by the salesperson for products consigned by the salesperson to the customer. Moreover, because the fact that customer authentication has been obtained can be proved, it is possible to prevent problems relating to the consigned products from arising.

### BRIEF DESCRIPTION OF THE DRAWINGS

FIG. 1 is a schematic view of a customer information management system in an embodiment of the present invention.

FIG. 2 is a block diagram showing a functional structure of essential parts of the customer information management system.

FIG. 3 is a diagram showing an example of categories that are registered in advance in a temporary information master register.

FIG. 4 is a flow chart showing the process when developing a new customer.

FIG. 5 is a view showing an example of a temporary information master register selection screen.

FIG. 6 is a view showing an example of a detail information input screen.

FIG. 7 is a view showing an example of a confirmation screen.

FIG. 8 is a view showing an example of an authentication screen.

FIG. 9 is a view showing an example of a customer information selection-input screen.

FIG. 10 is a view showing an example of a contract/statement of consignment.

FIG. 11 is a view showing the contents of a customer master register.

### DESCRIPTION OF THE PREFERRED EMBODIMENTS

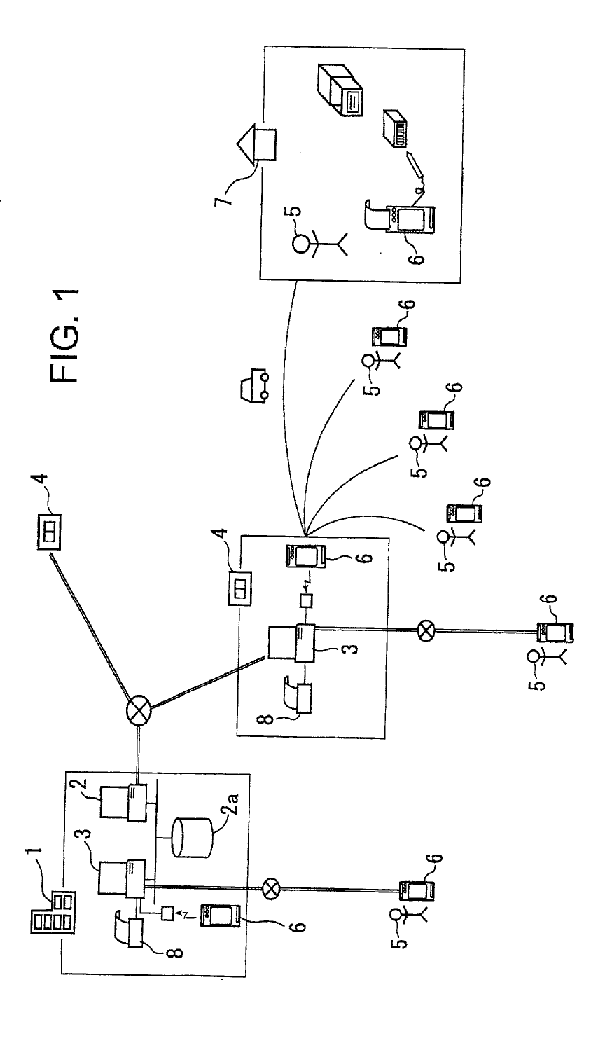

FIG. 1 is a schematic view of a customer information management system in an embodiment of the present invention.

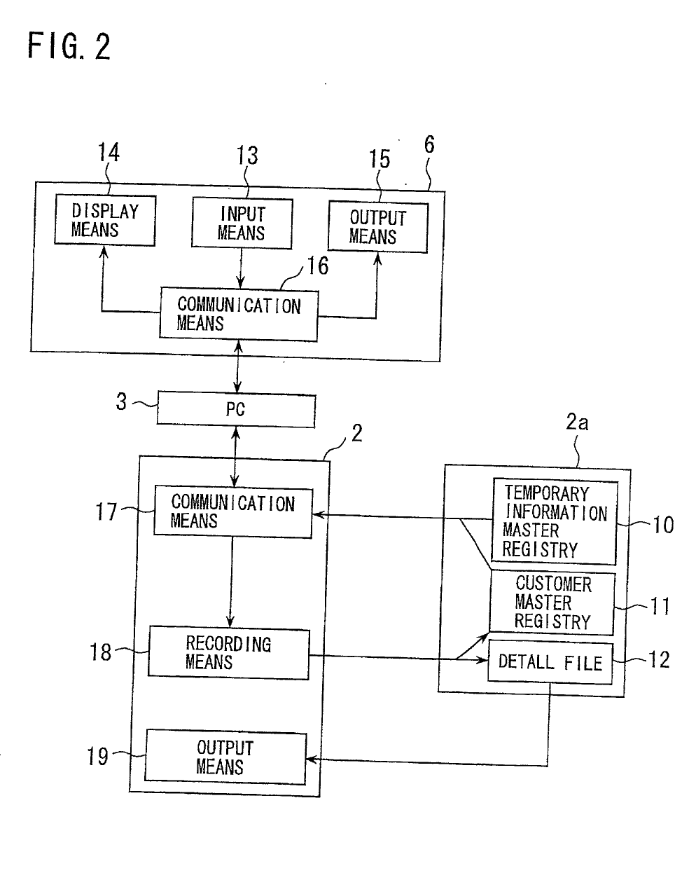

As is shown in FIG. 1, a server computer (referred to below as “SC”) 2 for managing a database (referred to below as “DB”) 2a (see FIG. 2) and a personal computer serving as a client computer (referred to below as “PC”) 3 connected via a network to the server computer 2 are installed in a head office 1. The PC 3 is also installed in each sales office 4 and each salesperson 5 carries a portable input/output terminal (referred to below as “HT”) 6.

When calling on a customer 7, the salesperson 5 inputs and records in the HT 6 information such as customer information concerning the customer and product detail information relating to the details of the products consigned to that customer. The information recorded in the HT 6 is transferred to the SC 2 via the PC 3. The SC 2 registers the information transferred from the HT 6 in the database DB 2a. If a request is made to the SC 2 by the PC 3 for information from the DB 2a, the SC 2 outputs the information acquired from the DB 2a to the PC 3. The PC 3 outputs this information in print on a medium such as printing paper using a printer device 8.

FIG. 2 is a block diagram showing a functional structure of essential parts of the customer information management system.

As is shown in FIG. 2, in the DB 2a stored are the temporary information master register 10 in which contents of part of the categories of the customer information and product detail information to be input using the HT 6 are registered in advance, a customer master register 11 in which customer information for each separate customer is registered, and a detail file 12 in which product detail information for each separate customer is registered.

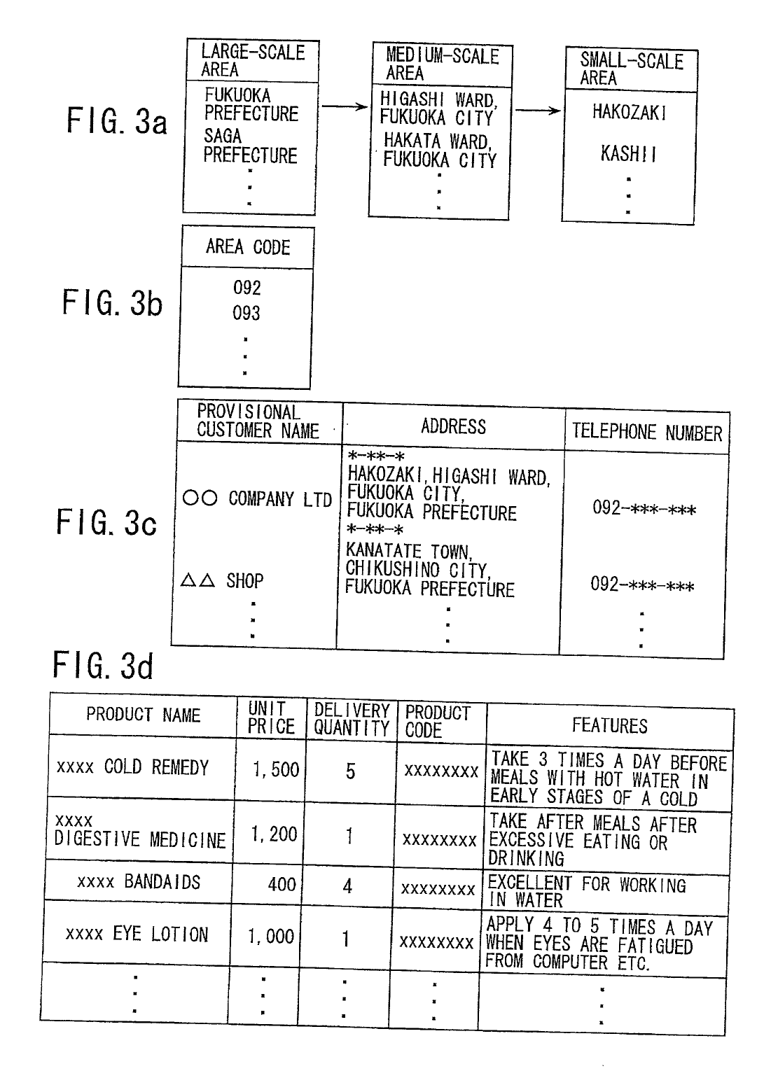

FIG. 3 shows an example of categories that are registered in advance in the temporary information master register 10.

FIG. 3(a) shows a list in which contents of the categories of a large-scale area, a medium-scale area, and a small-scale area have been registered relating to the address of a customer which serves as customer information. The large-scale areas, medium-scale areas, and small-scale areas may be classified respectively as, for example, a prefecture (province), a city, and a town or small district. FIG. 3(b) shows a list in which the contents of an area code category have been registered relating to the telephone number of a customer which serves as customer information.

When new customers are being developed, because the business activity is concentrated in a particular district, the categories of the large-scale area, medium-scale area, and small-scale area of the address of the business activity district as well as the category of the map code are registered in advance as customer information category contents. FIG. 3(c) shows a list of customers to whom a visit is planned in which the contents of each of the name (or company name), address, and telephone number categories of a customer whom the salesperson plans to visit have been registered as customer information. The contents of the categories may be created on the basis of electronic telephone book data or postal code number data.

FIG. 3(d) shows a consignment list in which the contents of the categories of the product name, unit price, consignment quantity, product code, and product feature description which serve as product detail information have been registered relating to the details of products to be consigned. Because the type and quantity of products to be consigned to a newly developed customer can be inferred from the experiences gained from the past consignment of call sales products, the above categories are registered in the temporary information master register 10 as the contents of product detail information categories.

Returning to FIG. 2, the HT 6 is provided with a character input device such as input keys, an input means 13 such as an image input device like a bar code reader or miniature camera, a display means 14 such as an image display device such as a liquid crystal display, an output means 15 such as an image forming device such as a printer for providing an output in print onto a medium such as printing paper or the like, and a communication means 16 for performing communication with the PC 3 using a communication medium such as a telephone circuit, an infrared communication device, or a PC card.

The HT 6 is connected to the PC 3 by the communication means 16 and acquires information from the customer master register 11 and the temporary information master register 10 accumulated in the DB 2a via the PC 3. The information acquired from the PC 3 is output by being displayed on the display means 14. The input means 13 is capable of performing the input of customer information via input keys or the like using the temporary information master register 10 acquired by the communication means 16, the input of product detail information via the input keys, bar code reader or the like, and the input via the input keys, miniature camera or the like, of an image of a fingerprint or face as authentication information that shows that customer authentication has been obtained. The communication means 16 connects with the PC 3 and acquires information of the temporary information master register 10 accumulated in the DB 2a, and also transfers information such as customer information, product detail information and authentication information which has been input using the input means 13. The information acquired using the communication means 16 and the information input using the input means 13 is capable of being output using the display means 14 and the output means 15.

The PC 3 is provided at least with communication means (not illustrated) for communicating with the HT 6 via a communication medium such as a telephone circuit, infrared communication device, or PC card. Moreover, the PC 3 is provided with input means and display means (neither of which are illustrated). The information transferred from the HT 6 can be modified or added by the input means, and the information transferred from the HT 6 and the information accumulated in the DB 2a can be output and displayed by the display means.

The SC2 is provided with a communication means 17 for performing communication with the DB 2a and the PC 3 using a dedicated line or a telephone circuit, a recording means 18 for making a connection to the DB 2a via the communication means 17 and recording customer information and product detail information, and an output means 19 for outputting information acquired from the DB 2a to the PC 3 or directly to an image forming device (not illustrated) such as the printer device 8.

The SC 2 transfers the temporary information master register 10 and the customer master register 11 of the DB 2a to the HT 6 connected via the communication means 17 and the PC 3. The SC 2 also acquires the customer information, product detail information, authentication information and the like transferred by the HT 6. When it has been confirmed that customer authentication has been received based on the authentication information transferred by the HT 6, the recording means 18 records the customer information and the product detail information transferred by the HT 6 in the customer master register 11 and the detail file 12 of the DB 2a, respectively. The information that is recorded in the detail file 12 of the DB 2a is capable of being output by the output means 19.

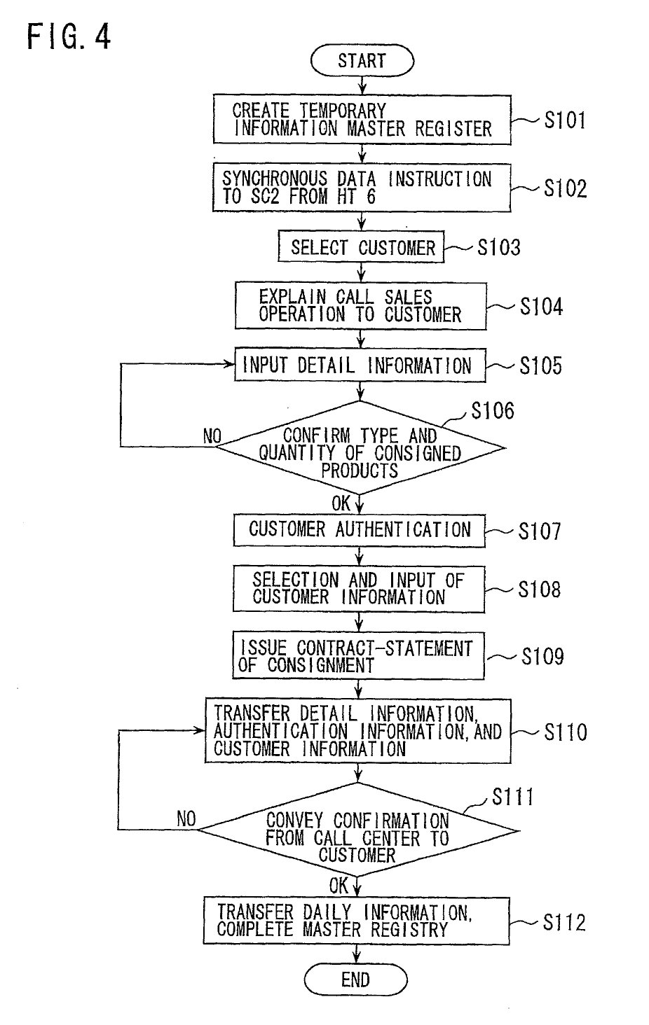

A description will now be given based on the flow chart in FIG. 4 of the customer information management method using the customer information management system having the above-described structure. FIG. 4 is a flow chart showing the process followed when developing a new customer.

Firstly, as shown in FIG. 3, in step S101 optional categories are selected from among each list registered in advance in the temporary information master register 10 and a temporary information master register to be acquired by the HT 6 is created. In step S102, by making a connection from the HT 6 to the SC 2 via the PC 3 and giving a synchronous data instruction from the HT 6 to the SC 2, the temporary information master created in step S101 is acquired in the HT 6.

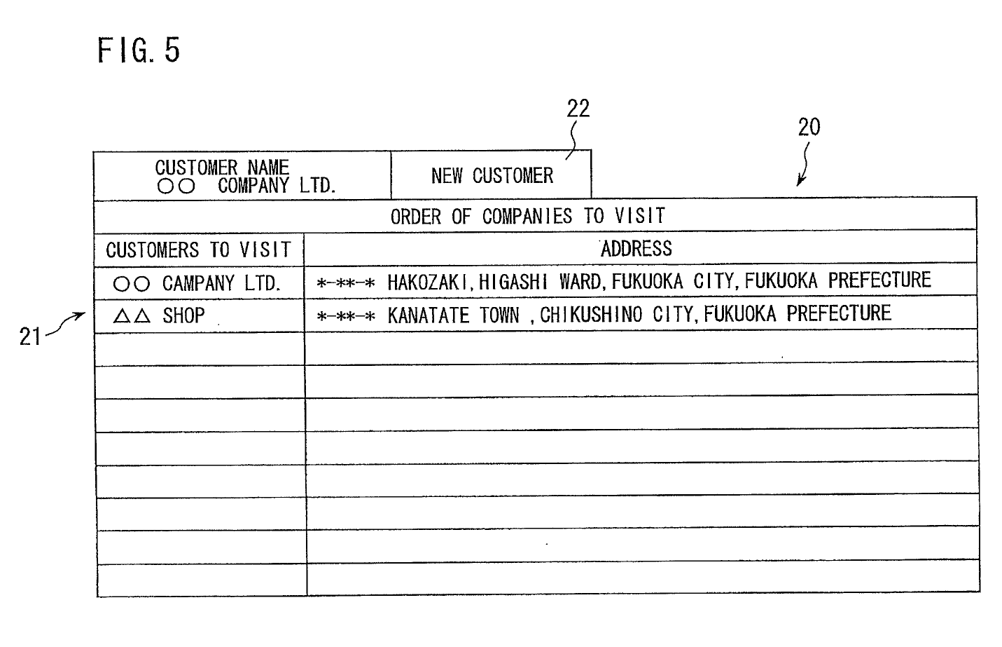

Instep S103, the salesperson operates the HT 6 and selects the customer information of the newly developed customer and the temporary information master register to be used for inputting the product detail information of the products to be consigned. FIG. 5 shows an example of a temporary information master register selection screen displayed on the display means 14 of the HT 6. On a temporary information master register selection screen 20 shown in FIG. 5 is displayed a list 21 of customers whom the salesperson plans to visit (see FIG. 3(c)) of the temporary information master register 10 acquired from the DB 2a. By selecting customers to be input from among this list 21, the salesperson does not need to again input contents for the categories already registered as shown in FIG. 3(c), but only needs to input contents in the remaining categories. If the customer to be input is not present on the list 21, it is possible to perform directly the input of the customer information and the like in step S108 described below. In this case, a “New Customer” button 22 is selected.

In step S104, the salesperson explains the sales method in which the products are firstly consigned to the customer and then the customer pays later only for the products that have been used and also explains the handling of the consigned products and sets the method of use and the call cycle.

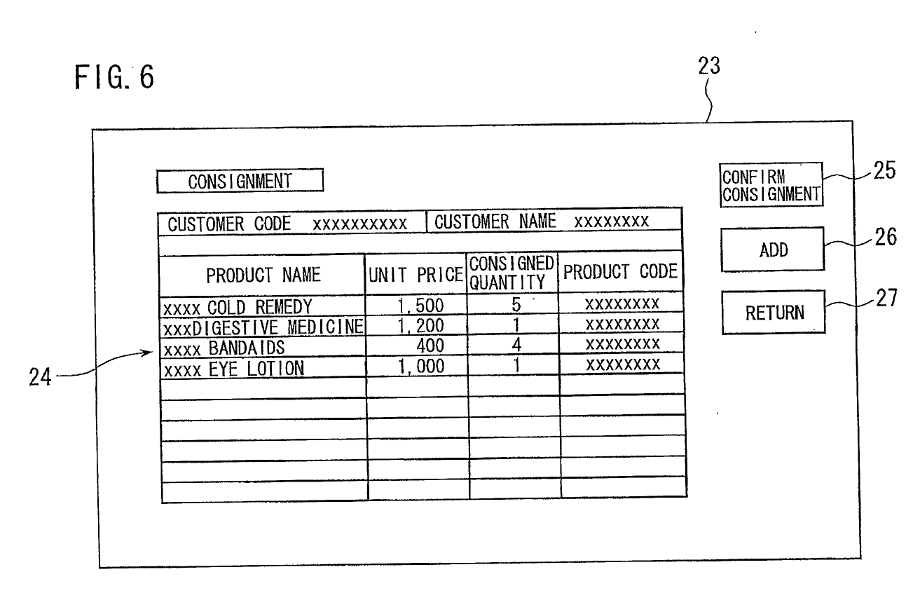

In step S105, the sales person operates the HT 6 and inputs the information on the details of the consigned products. FIG. 6 shows the product detail information input screen displayed on the display means 14 of the HT 6. On a product detail information input screen 23 shown in FIG. 6, is displayed a consignment list 24 (see FIG. 3(d)) of the temporary information master register 10 acquired by the DB 2a. When the consignment is to be made according to the contents displayed on this consignment list 24, the salesperson selects a “Confirm Consignment” button 25. When a consignment is to be made of the contents not shown on the consignment list 24, the salesperson selects an “Add” button 26. If an addition is made using the “Add” button 26, the addition can be made by scanning the bar code on the product using the input means 13 thereby displaying the added product on the consignment list 24. Note that a “Return” button 27 is used in order to return to the previous screen (the temporary information master register selection screen shown in FIG. 5).

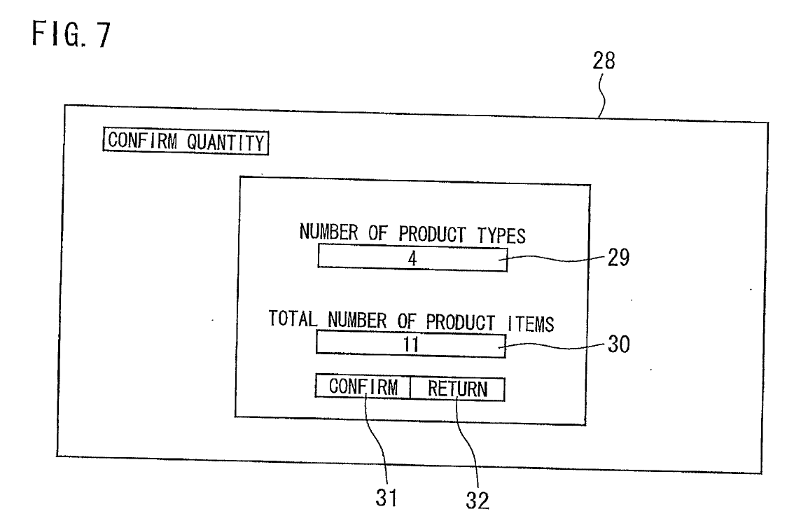

In step S106, the salesperson confirms the product detail information of the products to be consigned input in step S105 and the type and quantity of the products actually consigned. FIG. 7 shows an example of the confirmation screen displayed on the display means 14 of the HT 6. On a confirmation screen 28 shown in FIG. 7 displayed are an input column 29 for the input of the number of types of product consigned and an input column 30 for the input of the total number of consigned product items. The salesperson counts the number of types of product and the total number of product items to be actually consigned, inputs them respectively in the input columns 29 and 30, and then selects a “Confirm” button 31. The HT 6 compares the input contents of the input columns 29 and 30 with the number of product types and total number of product items calculated on the basis of the product detail information input in step S105 and, if there is no discrepancy in the input values, moves to step S107. If there is an error in the input values, the cause may lie in a mistake during the inputting process. Therefore, the routine returns to step S105 and the product detail information is input once again. Accordingly, the routine does not proceed to the next step when the input values are incorrect, thereby preventing any mistakes in the quantity of items consigned. Note that a “Return” button 32 is used in order to return to the previous screen (the product detail information input screen shown in FIG. 6).

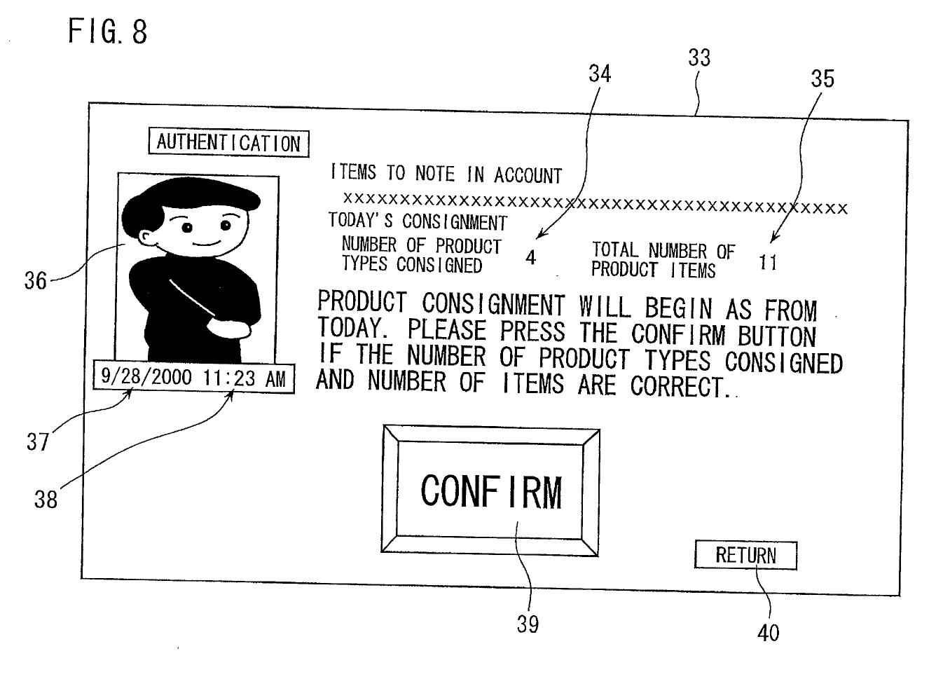

In step S107, the customer authenticates the contents of the contract and the consignment quantity. Confirmation by the customer of the confirmation screen 28 shown in FIG. 7 is sought and, if customer authentication is obtained, an image that enables the specific person to be identified such as the face of the customer is photographed using a camera or the like as the input means 13 of the HT 6, and the image is input with the date and time. Here, FIG. 8 shows an example of an authentication screen displayed on the display means 14 of the HT 6. On an authentication screen 33 shown in FIG. 8 displayed are the total number of consigned items 35 and the number of consigned product types 34 that have already been confirmed in step S106 as well as an image 36 of the face of the customer that was photographed, a date 37, and a time 38. A “Confirm” button 39 is then selected by the customer to show that customer authentication has been obtained.

Note that the “Confirm” button 39 is a sensor used as an input means that performs fingerprint identification. Alternatively, the “Confirm” button 39 may be means for inputting the handwritten signature or the actual voice of the customer. Whichever is used, the input confirmation is temporarily stored in the HT 6 as authentication information and is transferred to the SC 2 in step S110 described below. In the SC 2, the name of the customer and customer number and the like are automatically attached to the authentication information, which is then saved. If a problem occurs after a new customer has been created, or if an inquiry is made, a connection is made via telephone circuit or the like from the HT 6 to the PC 3, the inquiry is made, and the relevant data is acquired by the HT 6 from the PC 3 via the telephone circuit or the like. The customer information or the like is then displayed on the screen of the HT 6.

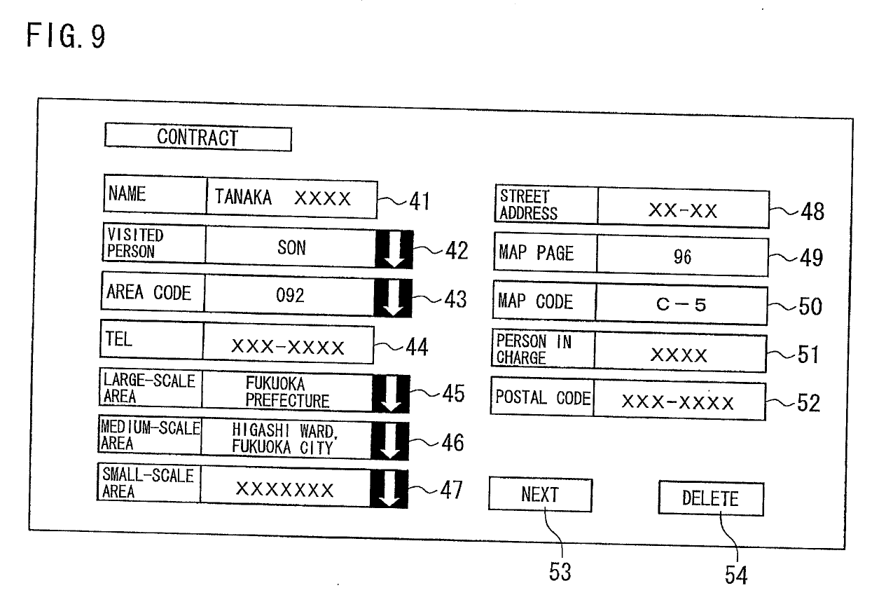

Once customer authentication is obtained, in step S108, the selection and input of the customer information is performed. FIG. 9 shows an example of the customer information selection-input screen. In FIG. 9, the personal name or company name of the customer, the telephone number, the street address, the map page, the code on the map page, and the postal code are directly input respectively in columns 41, 44, 48, 49, 50 and 52 respectively. In the input columns 42, 43, 45, 46 and 47, the categories of the visited person, the area code, the large-scale area, medium-scale area, and small-scale area can be selected from the lists acquired from the temporary information master register 10 of the DB 2a in step S102 and input. In an input column 51, the name of the person in charge is input in advance. The contents registered in advance for the customer selected in step S103 from the list 21 of the temporary information master register selection screen 20 in FIG. 5 are automatically input into each of the input columns 41 to 52 and then displayed. It is also possible to employ a structure in which related contents can be automatically selected for the input column 45 on the basis of the contents input into the input column 43. Once the inputs into each of the input columns 41 to 52 have ended, a “Next” button 53 is selected. If a “Delete” button 54 is selected, the contents input into the input columns 41 to 52 can be deleted and the input thereof carried out once again.

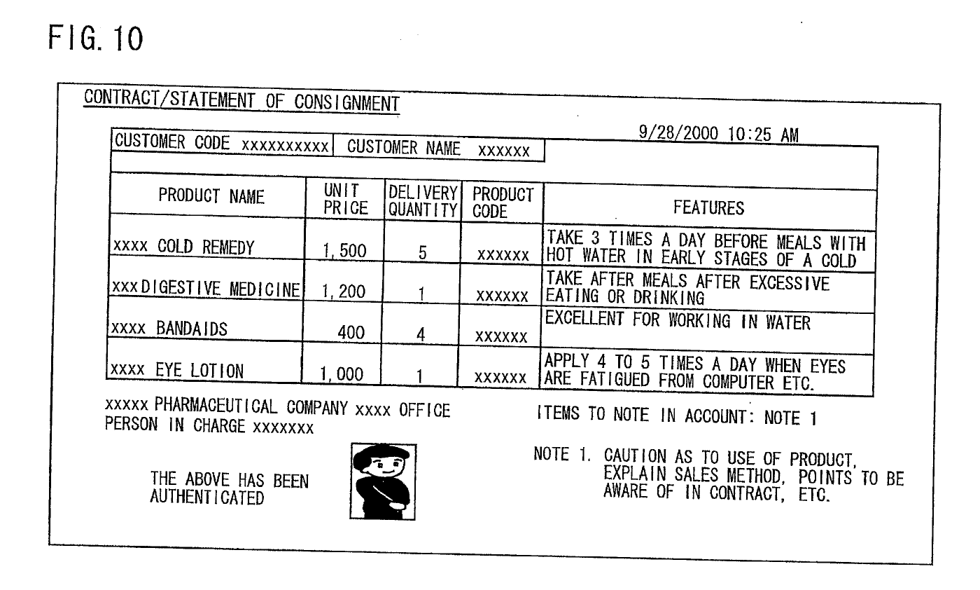

Next, in step S109, a contract/statement of consignment shown in FIG. 10 is issued. On the contract/statement of consignment shown in FIG. 10 recorded are the date of the consignment, the time, the customer code, the name of the customer, the name of the medicinal products to be consigned, the unit cost, the consignment quantity, the product code, features, the authentication result, and the like.

Instep S110, the product detail information input instep S105, the authentication information input in step S107, and the customer information input in step S108 are transferred. These pieces of information are sent to the PC 3 using the communication means 16 of the HT 6 and is transferred by the PC 3 to the SC 2. The information transferred to the SC 2 is received by the communication means 17 and recorded in the customer master register 11 and the detail file 12 of the DB 2a by the recording means 18. Then, the SC 2 acquires the information on newly registered customers from the customer master register 11 and the detail file 12 of the DB 2a and automatically outputs the information to a call center using the output means 19.

In step S111, based on the output information of the customer master register 11 and the detail file 12, the call center contacts of the customer 7 for confirmation via a telephone call, e-mail, facsimile or the like. If the contents of the customer master register 11 and the detail file 12 are confirmed, the routine moves to step S112. If any errors are found in the contents of the customer master register 11 or the detail file 12 by the confirmation, the salesperson returns to step S107 and carries out the customer authentication procedure once more.

In step S112, at the end of each day, the customer information, authentication information, and product detail information for the day which have been input into the HT 6 are sent to the PC 3. Then, the information is transferred from the PC 3 to the SC 2, and the registration in the customer master register 11 and the detail file 12 are confirmed by the recording means 18 of the SC2. The contents of the customer master register 11 and the detail file 12 are then fixed and become regular contents.

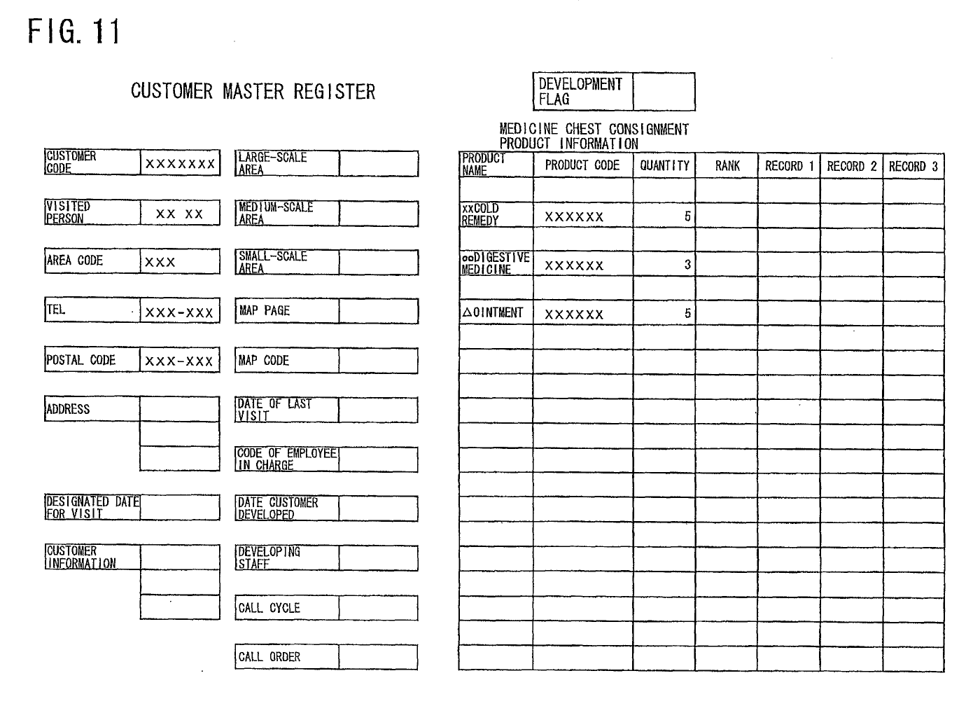

FIG. 11 is a view showing the contents of the customer master register 11.

In the customer master register 11 shown in FIG. 11, the customer information and the product detail information on the consigned product are recorded. The customer information includes the customer code, the customer name, the are code, the telephone number (TEL), the postal code, the address, the date designated for the visit, the customer information, the large-scale area code, the medium-scale area code, the small-scale area code, the map page, the map code, the date of the last visit, the code of the person in charge, the date the customer was created, the person to be visited, the call cycle, and the visiting order. The product detail information includes the name of the product, the product code, the quantity and the like. While the customer master register 11 is not regular, a development flag is set to stand. Once it becomes regular in step S112, the development flag is removed, thereby the customer master register 11 being confirmed to be normal.

As has been described above, according to the customer information management system of the present embodiment, it is possible to more easily input the customer information, product detail information, and authentication information for a customer newly developed by the salesperson 5 into the HT 6 based on the temporary information master register 10 of the DB 2a acquired by the HT 6. Moreover, after every input of the information into the HT 6, the salesperson transfers the input information to the SC 2 and registers it in the customer master register 11 and the detail file 12 of the DB 2a. Thus, the call center acquires the customer master register 11 and the detail file 12 from the DB 2a and then outputs these, thereby ascertaining the contract contents and responding to the customer immediately. In addition, because it is possible to prove from the authentication information that customer authentication has been obtained, problems concerning consigned products can be prevented.

Note that the HT 6 described in the present embodiment maybe a mobile telephone capable of connecting to the Internet. By making a connection to the SC 2 via the Internet using this type of mobile telephone, as in the above-described embodiment, the temporary information master register 10 can be acquired by the mobile telephone from the DB 2a, and the customer information, product detail information, and authentication information input into the mobile telephone can be registered in the DB 2a.

In addition, because the products are managed using bar codes, it is even possible to make an inventory every day at the end of that day's business.

While the preferred form of the present invention has been described, it is to be understood that modifications will be apparent to those skilled in the art without departing from the spirit of the invention. The scope of the invention, therefore, is to be determined solely by the following claims.

What is claimed is:

1. A customer information management system for use in call sales comprising:
a portable terminal used for inputting customer information relating to a newly developed customer and product detail information relating to details of a product consigned to and left with a customer; and
a server computer capable of making a connection to a database used for storing a temporary information master register in which contents of part of categories of the customer information or the product detail information input using the portable terminal are registered in advance, a customer master register in which customer information relating to each of the customers is registered, and a product detail file in which product detail information relating to each of the customers is recorded, wherein the portable terminal comprises:
means for making a connection to the server computer and acquiring the temporary information master register;
means for inputting the customer information and product detail information using the acquired temporary information master register; and
means for making a connection to the server computer and transferring the input customer information and product detail information,
and the server computer comprises:
means for recording the transferred customer information and product detail information in the customer master register and the product detail file respectively; and
means for acquiring the customer master register and the product detail file from the database and outputting the customer master register and the product detail file.

2. The customer information management system according to claim 1, wherein the portable terminal further comprises: means for outputting the input product detail information, and means for inputting authentication information showing that customer authentication has been obtained for the output product detail information.

3. A customer information management method for use in call sales in which customer information relating to a newly developed customer and product detail information relating to details of a product consigned to and left with a customer are input using a portable terminal; and the input customer information and product detail information are transferred to a server computer for managing a database for storing a customer master register in which customer information relating to each of the customers is registered and a product detail file in which product detail information relating to each of the customers is recorded, wherein:
contents of part of categories of the customer information or the product detail information to be input using the portable terminal are registered in advance in the database as a temporary information master register; the temporary information master register is acquired by being connected to the server computer using the portable terminal; the customer information and product detail information are input into the portable terminal using the acquired temporary information master register, the input customer information and the product detail information are transferred to the server computer by being connected to the server computer using the portable terminal, the transferred customer information and product detail information are recorded in a customer master register and a product detail file respectively in the server computer, and the customer master register and product detail file are acquired from the database in the server computer and output.

4. The customer information management method according to claim 3, wherein, after the customer information and product detail information have been input into the portable terminal, the input product detail information is output using the portable terminal, authentication information showing that customer authentication of the output product detail information has been obtained is input, and the input authentication information is transferred to the server computer.
